(19) United States
(12) Patent Application Publication
(10) Pub. No.: US 2017/0316316 A1
(43) Pub. Date: Nov. 2, 2017

(54) SYSTEM AND METHOD FOR VISUALIZING AND SIMULATING PERSONAL KNOWLEDGE STRUCTURES IN A COMPANY

(71) Applicant: PETER FINK, Bremen (DE)

(72) Inventor: PETER FINK, Bremen (DE)

(21) Appl. No.: 15/141,299

(22) Filed: Apr. 28, 2016

(51) Int. Cl. G06N 5/02

(52) U.S. Cl. CPC G06N 5/022

(57) ABSTRACT

The invention relates to a system for visualizing and simulating personal knowledge structures in a company which has one or more business units. It comprises a first server for storing a first dataset, which describes a model of the company structure, wherein for each employee position in the company an employee target profile is defined, which comprises an employee target competence profile; and for storing a second dataset, which specifies the sales achieved for the individual business units; and for storing a third dataset, which depicts recorded employee actual competence profiles. Furthermore, it contains a second server which comprises a program that calculates a plurality of indexes based on the data of the first dataset, second dataset, and third datasets, in particular the human potential and/or the economic temperature. In addition, the system has a graphic user interface, which displays the calculated indexes for each employee actual profile and/or each business unit at a corresponding point in the pictured company structure.

### FIELD OF THE INVENTION

The invention relates to a system and method for visualizing and simulating personal knowledge structures in a company that is made up of one or more subunits.

In the present invention, the term company represents all business entities regardless of their functional or economic objective, i.e. a company is understood as any authority, institution or organization in all industries and of all sizes.

The term knowledge structures can be understood in the context of the present invention as those structures that represent the individual knowledge of each employee in a company using predetermined sizes.

The knowledge of an employee in a company is limited not only to his or her competence (hard skills), but far more. So all human skills and knowledge (soft skills), for example experience, teamwork and communication skills, are included in the knowledge of an employee.

These skills can be recognized in the form of employee competence profiles, where the evaluation of skills may take place by self-evaluation (self-assessment) as well as through assessment by other employees or third parties (external evaluation).

In addition to employee competencies regarding a particular staff position in a company, further human skills and knowledge (soft skills) can be assigned in addition to the required professional qualifications. Furthermore, job-related tasks and requirements can be assigned (job profile) so as to give a complete target profile for each staff position.

### BACKGROUND

While the expertise of an employee of a certain measurability is accessible, it is more difficult to assess the human skills and knowledge described and thus harder for a company to quantify. Decisions in personnel development are therefore often taken on a personal level and require a great deal of effort on the part of the personnel department to find a suitable candidate for a certain position, or to restructure. Starting at a certain number of employees the personal judgment of each employee is hardly affordable to an economically reasonable extent.

### BRIEF DESCRIPTION

The object of the present invention is therefore to provide a system and method for visualizing and simulating personal knowledge structures in a company, which allows to sustain control of the strategic personnel development in a company, while making the individual knowledge of each employee quantifiable and thus manageable and monitorable.

This objective is achieved by a system of the aforementioned type with a first server for storing a first set of data describing a model of a company structure, whereby in the company for each staff position an employee target profile is defined, which includes an employee target competence profile; and for storing a second data set, which indicates the revenue generated for the individual company units and employees; and for storing a third set of data collected, which contains employees actual competence profiles; with a second server having a program that calculates a plurality of indexes, based on the data of the first, second and third data sets, in particular, the human potential, the economic temperature and the competence quality, and which has a graphical user interface, which displays the calculated indexes for each employee actual competence profile and/or for each company unit in a corresponding location in the above given company structure.

The invention is based on the recognition that the complexity of today's company structures, especially in companies with a large number of employees, steadily increases, what makes the management of strategic personnel development increasingly difficult. It is a common practice, however, to use in purchasing or inventory management computer-based surveillance and control programs under the maxim of economic optimization, there are no such computer-based control programs in the field of strategic personnel development in a company so far.

The model of the company structure reflects the company's existing hierarchies and divides the company into units, which are in turn divided into sub-units to the individual staff positions. This is an illustration of the organizational structure of a company. In addition, the model can contain information about sequences of operations, also depicting the operational structure, where both organizational models are interlocking and mutually independent.

From a model description of a staff position a suitable target employee competence profile is created, as a part of an employee target profile, which reflects, besides professional skills, human knowledge and skills (competences). So the employee target competence profile f©r the staff position of a head of department will have, for example, in addition to professional qualifications, leadership and organizational skills, while the target employee competence profile for the staff position of an Account Manager, for example, in addition to professional skills, may require communication and teamwork skills.

To create the employee actual competence profile is required that skills and qualities listed in an employee target competence profile, be recorded for every employee through self-assessment and/or external evaluation by professionally trained persons or colleagues. The external and/or self-evaluations can be produced by an integrated support in the method profiling in the form of computerized audience responses. As assessment factors other soft factors can be incorporated, as described in “Golden Profiler of Personality” (GPTP) Copyright 2002, 2004-Golden, LLC, Estero, FLA. USA, licensed to Verlag Hans Huber, Hogrefe A G Bern, Copyright of the English Version in 2013 and as described in “ARPe Authority Responsibility Power expanding” by Richard Bents and Reiner Blank, Copyright 1998, 2002 by Future Systems Consulting GmbH.

The modular design of the system, which provides a separation of the calculation methods by the use of multiple data sets, allowing the possibility that remote diagnosis is given to both the local users of the system as well as third pay access. The arithmetic operations for determining the indexes (human potential, economic temperature, specificity, expertise quality, redundancy, efficiency, stability) can be made separately from the technical work for safety reasons on a separate server.

Before the subsequent calculation of the indexes on the basis of employee actual competence profile and employee target profile is performed externally, anonymization of the related data in accordance with the applicable data protection regulations can be performed beforehand. The anonymization is then reversed when importing the calculated indexes, such that the data will be personalized again.

In order to especially subject the human skills and competencies to a quantifiable scale, the human potential is calculated for each employee from the sum of the skills and qualities of human potential. The human potential is calculated here by the commonly used in information theory formula for calculating entropy:

$$H = - {\sum }_{k} \frac{{m}_{k}}{M} {log}_{2} \frac{{m}_{k}}{M}$$

$$where$$

$$M = {\sum }_{k} {m}_{k}$$

and mₖ represents a share of ability of an employee at the sales.

A detailed derivation of human potential and further execution in the economic use of knowledge functions can be found in DE 101 05 314 A1. All of the indexes derived from the human potential are also suitable to be incorporated as measures within the meaning of the present invention and are herein incorporated by reference.

The economic temperature results from staff reported sales divided by its human potential.

The competence quality is to be understood in the present invention as the degree of specialization or the breadth of knowledge of the combined employees of a company unit. The competence quality arises from the collective human potential of the individual employee actual competence profiles as their superposition, divided by the average human potential belonging to corresponding company unit employees. Closely related to the competence quality is the index of knowledge redundancy. This arises from the number of employees in a business unit divided by the competence quality.

Another advantage of the present invention is that it allows a business assessment of knowledge in a company, since each individual factor affects the economic temperature. Further, various operational development models can be simulated by incorporating future skills required (e.g. knowledge of Chinese, Node programming and so forth) in the evaluation of the employees, to look at the areas where skills gaps could arise to counteract them early. Thus, the present system allows a determination and guarantee the necessary today and in the future for the success of important knowledge and skills of the employees, identifying and conveying knowledge and skills that significantly determine the company's success, a reduction of not more needed available knowledge redundancies, an observation of knowledge losses that occur due to the demographic development and presentation of proposals on both the knowledge as well as on employee level to mitigate and prevent loss of knowledge, as well as restructuring of personnel and management organization based on the obtained results.

In a preferred embodiment of the present invention, the graphical user interface is configured to assign to an individual employee an actual competence profile within the represented company structure through user input of another staff position in the company structure, which then automatically recalculates the indexes.

The allocation can be carried out via simple drag & drop, meaning the clicking of an employee actual competence profile and the “pulling” of the employee actual competence profile to another staff position within the display of the graphical user interface. Alternative assignment possibilities are also conceivable, such as selecting the employee actual competence profile, selecting an option “Cut”, selecting a staff position and the option “Insert” being selected. Regardless of the mapping method, recalculation or revaluation after reallocation of the resulting indexes is automatically carried, out.

In a further development of the preferred embodiment, the graphical user interface is designed as an alternative or addition, to make it possible through user input to optimize an index for a company unit selected, then automatically reassign the employee actual competence profiles on the staff positions in the company unit, such that the selected index for the business unit is optimized.

For a personnel development in a company it is not only important that each staff position or any other workplace is occupied with a suitable employee who brings professional qualifications and appropriate human skills and qualities, but also how the individual employee in a company unit introduces knowledge and skills which are redundant or unique. In order to optimize the interaction of individual knowledge and skills, the invention, is carried out under a team harmonization

Furthermore, the system allows an appreciation of employee competencies that are required only in foreseeable future or a depreciation of such skills, which are less important in the foreseeable future, or are no longer needed.

As an example: The target profile of a team that is familiar with distribution and online marketing of products on the French market requires good knowledge of French, IT skills and organizational skills, and is composed of three employees, where for the sake of clarity, each employee brings two qualifications. The employee A speaks very good French and has excellent IT skills. Employee B also has good IT skills and is very organized. Consequently, the qualifications of the employee A and B meet already requirements of the desired profile of the team. Employee C could therefore bring any two of the three skills. If the employee C also brings good IT and knowledge of French to the team, the redundancy in the team with respect to the IT skills would be further increased, while employee B would be the only one with the organization skills. The case of failure of the employee B therefore threatens the work of the entire team to fall into chaos. Ideally employee C should bring IT skills and organizational talent. Then none of the target skills are busy singularly, nor have another excessive redundancy. This illustrative example shows that with larger company structures and a large variety of covered skills such optimization is to be performed without hardly any technical support. Furthermore, the system according to the invention can also be used, for example, to simulate the effect of continuing education and training of individual employees on the indexes of the company units. Thus, a certain ability in one or more employee actual competence profiles is strengthened (virtually raised), which automatically recalculates the indexes for the company unit, and in this method, for example, the redundancy can be increased in a unit to a desired level.

In a further development of the previous, preferred embodiments, the graphical user interface is designed as an alternative or addition, in order to create a new company unit defined by at least one staff position, where for each of at least one staff positions in the company unit a newly defined employee target profile is defined, where each employee each target profile is automatically linked to an employee actual competence profile, so that an index for the newly defined company unit is optimized.

The present invention allows thus for providing support for a process of team building efficiently, taking into account predetermined criteria. Once the target profile for the new entity is set, an optimized allocation of staff positions is automatically determined by use of the existing employee actual competence profiles. It is also possible to fill one of the staff positions manually, after which the system according to the invention proposes candidates for the additional staff positions from the existing employee actual competence profiles. Again, a calculation of the indexes for the new company unit takes place with each selection of a new employee actual competence profile.

In a further development of the foregoing, preferred embodiments, the system is designed as an alternative or addition, to alert the user when an employee actual competence profile or an index having a deviation from the employee target profile or a reference index exceeds a defined threshold.

The user interface is designed such that over-challenged and/or under-challenged individual employees and parent company units (teams or departments) are instantly recognizable. All incremental encoders can be used to indicate a higher-level stability index.

The alarm can be carried out via visual or audible signals. Especially in complex company structures such feature is of particular advantage to be an early warning of over-challenged and/or under-challenged individual employees, and through specialized training or altering of the roles, possible adverse effects of over-challenge and/or under-challenge, such as, for example, above-average absenteeism or above average error rate, are prevented. The inventive system can thus be used as an instrument for maintaining health, illness prevention and health monitoring.

The visual alarm can be produced by a list of the relevant employee actual competence profiles in a separate section of the graphical user interface, where after selecting one of the listed employee actual competence profiles the relevant company unit is displayed automatically in another area of the>display of the graphical user interface. Alternatively, the visual alarm can also be done within the company structure simply by a color marking of those indicators or employee actual competence profiles, which have a predetermined deviation from the nominal indexes, for example, the index, the skills profile or the number or the employee actual competence profile being outside the deviation tolerance from a set point, lights the associated indicator in red. If an index and/or profile is within the deviation tolerance, the index, the skills profile or the number or the employee actual competence profile lights the associated indicator in green. Other visual effects, drawing the attention of operators to an employee actual competence profile with significant deviations from the reference profile, are also conceivable.

In another embodiment of the present invention, the employee target profile includes, for each staff position in the company defined according to the operational structure, workplace target profile that includes the provided incoming and outgoing information inflow, and the system comprises a unit for detecting an incoming and outgoing information flow, in particular by reading incoming and outgoing work documents for each staff position for detecting the workplace actual profile for each staff position in the company, and a unit for adjusting the workplace target and actual profile for each staff position with respect to the organizational structure, whereas the unit marks when a predefined deviation between workplace target and actual profile is exceeded, and identify them though the graphical user interface.

In the present embodiment, the employee target profile includes for each staff position an employee competence target profile that can be derived from the enterprising specific operational structure, as well as from a workplace job target profile that can be derived from the operational structure of the company. Also, the organizational objectives, tasks and expected from the employees competencies are defined, including the operational structure, what information, preferably in the form of work documents, in what way and at what time must reach the staff position to guarantee an optimal workflow.

The employee actual profile for each staff position therefore includes not only the employee actual competence profile of that employee who held the position, but also the workplace actual profile. This allows not only the employee competence profile comparison but also balance between the workplace target profile and the workplace actual profile according to the operational structure.

Therefore, information with respect to the operational structure are entered in the employee target profile for each staff position, which are necessary to perform the tasks which are attributed to a staff position. In case of incomplete or late transmission of information, the employee can not meet expectations associated with his job, what affects each parameter to be calculated, in particular, the economic temperature. By that a tailed communication matrix to the employee target profile, can be adjusted during input of information for a specific staff position immediately if the necessary information is such that the following sequence of operations can be performed without problems. This may, in particular, be carried out by an automatic scanning of incoming documents on the basis of predetermined criteria such as checking required entry fields, time constraint, etc. So automatically captured workplace actual profile for a staff position is so compared with the targeted workplace target profile, as well as the employee competence actual profile, and visually made visible through the user interface. In case of deviations to a predetermined value, an optical highlighting or different warning are displayed.

This allows the company internal operational structure for the employees to be transparent and vulnerabilities can be quickly identified and corrected. Furthermore, it is possible to involve the employees in the elimination of vulnerabilities and early counteract possible consequences of a faulty process organization as overwork, frustration or burnout of employees.

In another further shaping of the preceding embodiment, the system comprises a unit for automatically notifying a news channel, if the above information is ended incomplete or delayed. Thus, to the sender of a work document a message or warning will be sent if the required information for the farther processing should not have been communicated or submitted late.

Another aspect of the invention is a method for visualizing and simulating personal knowledge structures in a company that has one or more company units, where the method comprises:
inputting the first data, which reflect the company structure and define target competence profiles for each staff position within the company structure;
inputting the second data, which reflect the company's turnover in the company structure;
inputting the third data recorded, that depict employee actual competence profiles,
calculating predefined indexes based on the first, second and third data, finding in particular, the human potential, the economic temperature, and the competence quality;
displaying, company structures with a graphical user interface, where the indexes in accordance with the relevant employee actual competence profiles are displayed for each staff position and each company unit within the company structure.

The comments on the indexes, in particular, the human potential and the economic temperature, as well as the competence quality or redundancy claims are asserted in accordance with the measures taken for a version of the inventive system.

In a preferred embodiment the method further comprises the steps of:
assigning individual employee actual competence profiles within the represented company structure through a user input device to another staff position in the company structure, and
recalculating and updating the display of the indexes for each staff position and/or company unit.
   In a further development of the embodiment, the method comprises alternative or additional steps of:
selecting an index to be optimized for a company unit through a user input device, and
automatic reassignment of employee actual competence profiles on the staff positions in the company unit, where the selected index is optimized for the company unit.

In a further development of one of the preceding embodiments, the method comprises alternative or additional steps of:
creating a new company unit with at least one staff position, which has an employee target profile for each of at least one staff positions in the newly defined company unit, and
automatic association of each target profile with an employee actual competence profile, so that an index for the newly defined company unit is optimized.

In a further preferred embodiment, the employees target profile for each staff position in a company, in accordance with a defined process organization, includes workplace target profile, which includes provided incoming and outgoing information inflow. Further, the method comprises the steps of:
detecting an incoming and outgoing flow of information, especially by reading incoming and outgoing work documents for each staff position for captured the workplace actual profile for each staff position in the company
balancing the workplace target and actual profile for each staff position with respect to the operational structure, where at a predefined deviation between workplace target and actual profile relevant employee profiles is marked and identified through the graphical user interface.

In a further design of the previous embodiment, the method comprises a transmitter automatically notifying a sender of information, if the above information is sent in accordance with workplace target profile for the receiving staff position is incomplete and/or delayed. Thus, a message or warning can be automatically sent to the sender of a work document, if the information required for the further processing should not have been submitted or submitted late.

### DESCRIPTION OF THE DRAWINGS

FIG. 1 shows a flow diagram of the operation of the inventive system.

FIG. 2 shows a preferred embodiment of the system according to the invention.

FIG. 3 shows a flow diagram based on an exemplary defined company structure.

FIG. 4 shows a preferred embodiment of the user interface.

FIG. 5a shows schematically the transmitted information between workplaces in accordance with a defined operational structure.

FIG. 5b shows schematically the communication matrices for a flow of information to be created automatically.

### DETAILED DESCRIPTION

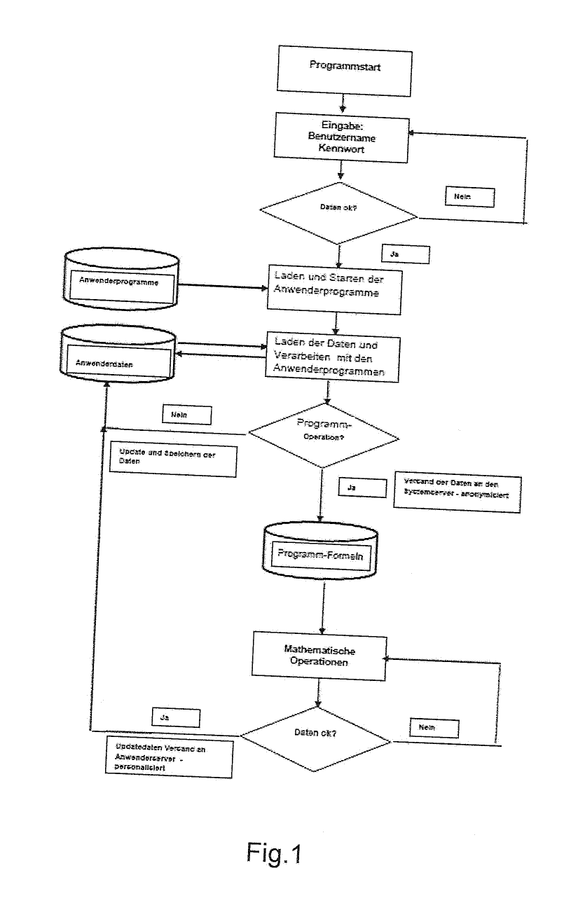

The flow chart illustrated in FIG. 1 shows the operation of the system according to a preferred embodiment. After starting up the system, the user is optionally asked about his credentials. If username and password are authenticated, the actual user program is loaded.

The user program includes a graphical user interface by which a user gets access to the system. Thus, this user interface is the interface by which the system is accessible for the user.

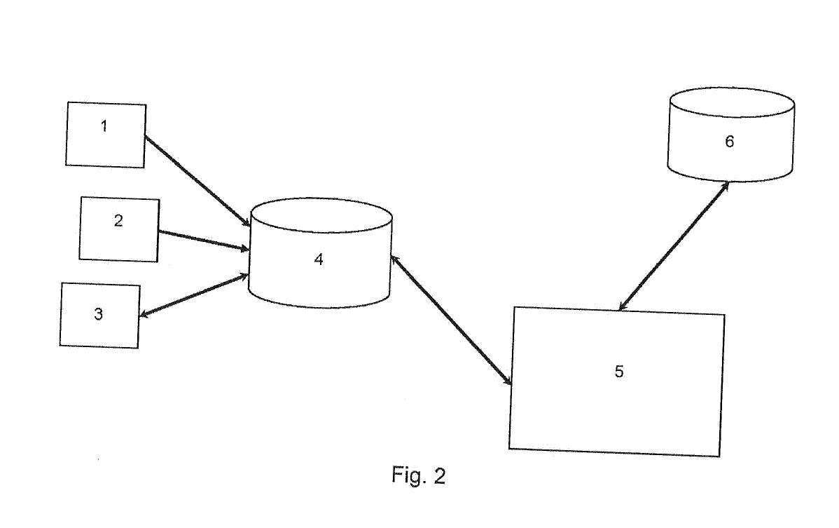

FIG. 2 shows an example of construction of a preferred embodiment of the present invention. Using the graphical interface, users 1, 2, 3 receive access to the system, where it is indicated by the arrows that users 1 and 2 are only authorized for data entry, for example to enter their self-assessment, which can also be done through the user interface. User 3 by contrast may also receive data calculated by the system i.e. view, analyze and process data in order to input the data again into the system. Granting of access rights is centralized and is subject to the authorizations and functions of the individual user. Therefore, while the staff of a personnel department has more extensive access rights to both the employee actual profiles as well as the stored structures and employee target profiles, you can allow department managers, for example, to use only the functionality to determine an optimum team composition/harmonization, managing them without access to details of an employee profile.

Further, the assignment of different access rights also allows external users to provide some insight without revealing sensitive information.

It is possible to collect all relevant data in advance, for example, by means of a company intern, and for this to be made anonymous before being sent to a server. ⁵

Indexes of strategic personnel development are calculated on a server accessible via a network which loads for each application, with the system-related program components and formulas loading from a host server. ⁶

One possible source of the user program from which it can be loaded is the Internet, where the user program can be stored on a physical or virtual server. Alternative procurement options on media of all kind are also possible.

If the application program is loaded, the user data is loaded next. These include not only the company structure (departments, divisions, teams, individual staff positions), but also the employee target and actual profiles, which have been previously recorded in a predetermined format. The employee profiles include information on the skills and knowledge of employees in form of employee competence profiles. The employee actual competence profiles are possibly created on the basis of self-assessment as well as external evaluation by colleagues and/or specially trained personnel (psychologists, profilers, etc.) or a combination thereof.

The subsequent calculation of the indexes is provided externally, where a anonymisation of records in accordance with the applicable data protection regulations can be done in advance.

Based on the optionally anonymous input data the application program calculates a set of indexes for each level in the corporate structure, including:

| Indexes for Subsets | Company | Department | Staff |
|---|---|---|---|
| Human | X | x | X |
| Potential | | | |
| Economic | X | x | X |
| Temperature | | | |
| Specificity | | | X |
| Competence | x | x | |
| Quality | | | |
| Redundancy | x | x | |
| Effectiveness | x | x | |
| Stability | x | x | |
| Efficiency | x | x | X |
| Sales | | | |
| Shifting | x | x | |
| Demographics | | | |
| Overwork | x | x | X |
| Underwork | x | x | X |
| Health | | | |
| Cost | x | x | X |
| Development | | | |
| Personal | x | x | X |
| Development | | | |
| Sales | x | x | X |
| Development | | | |
| Personal | x | x | |
| Quality | | | |
| Sustainability | x | x | X |

The human potential is calculated here by the formula common in information theory for calculating the entropy:

$$H = - {\sum }_{k} \frac{{m}_{k}}{M} {log}_{2} \frac{{m}_{k}}{M}$$

$$where$$

$$M = {\sum }_{k} {m}_{k}$$

and in consideration FM all the sum of all skills mₖ of an employee represents.

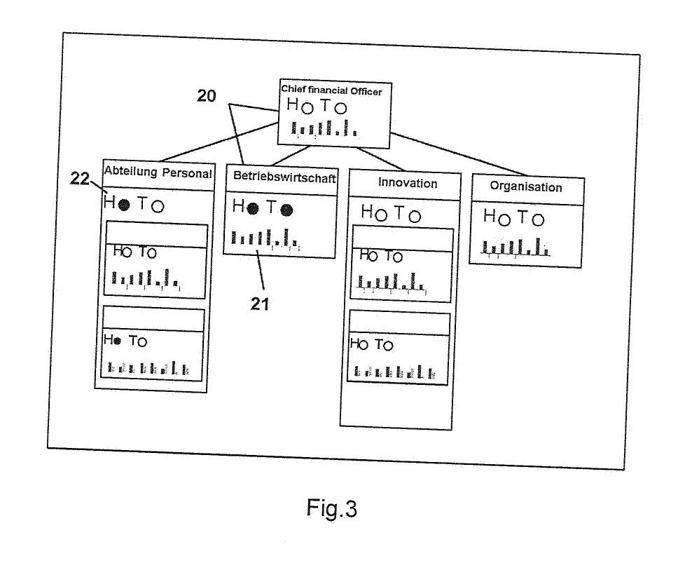

A detailed derivation of the human potential as well as further execution of the economic use of knowledge functions can be found in DE 101 05 314 A1. The more evenly distributed the individual skills are, the higher the calculated human potential of a person, and the more specific the skills, the lower the calculated human potential. FIG. 3 shows three exemplary employee actual competence profiles, where the first has a very large human potential, the second having a very low human potential and the third human potential is in the intermediate region of the previous examples.

The derivation of other variables such as the economic temperature, redundancy, efficiency and stability are shown in detail in DE 101 05 314 Al. They all make possible characteristics of the present invention and are hereby referenced to the local disclosure expressly incorporated within.

Furthermore, skills and qualifications of employees, which will be important only in the foreseeable future, will be recognized with help of indexes in the form of a write-up (or importance decreasing ability in the form of writing) in the assessment of knowledge in a company. Through the supply and amortization will be future developments included in the calculation of current indexes such as the economic temperature. Also can be multiplied by adding up all the knowledge and skills with employees who posses these skills, multiplied by the duration of knowledge, to calculate the total value of the information, which has meaning at a company or for sale. In addition, an economic evaluation (BWA) of existing knowledge in a company is made possible, This can also be incorporated into the economic evaluation of the other company's data to make the value of existing knowledge detectable.

After calculating the indexes for each staff position, and for the individual company units, the calculated values are output to the user, where possibly a personalization takes place, so the prior anonymisation is reversed upon entry into the internal scope. The determined indexes can be stored locally and used by the graphical user interface for further processing.

To allow the graphical interface user presentation of the indexes per company unit, being the smallest unit of an individual employee, FIG. 3 shows a flow chart based on a defined company structure, where summed employee actual competence profiles are in this preferred embodiment, and for each company unit 20 employee actual competence profiles are specified and certain, and specify selected indicators showing 22 colored icons indicating whether the indicators are within a certain tolerance, for example, signaled by a green icon, or, outside a predetermined tolerance, for example by a red, possibly flashing icon. By clicking on a particular business unit, this can be selected in a detailed view, and with this type of navigation to the lowest level, can thus continue to the individual employee actual competence profiles through the company structure.

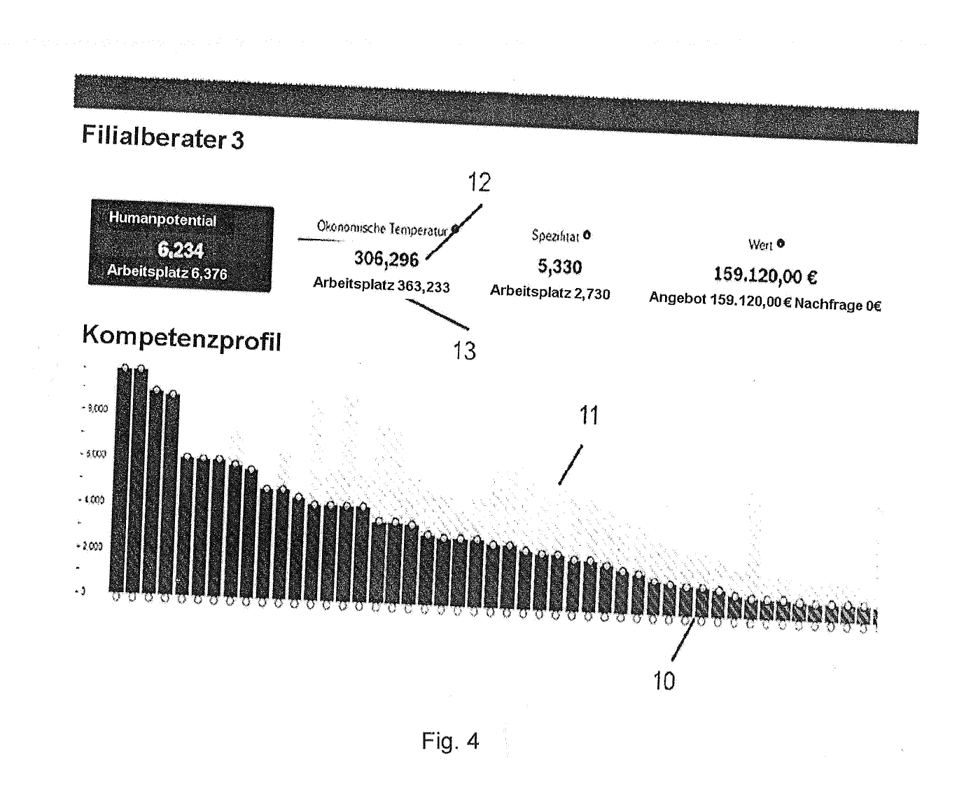

In FIG. 4, a preferred embodiment of the user interface is shown, in which the actual employee competence profile 10 is placed on the employee target competence profile 11 of a selected staff position, so that a simple optical adjustment in seconds allows the user to review this possibility. Alternatively and/or additionally, the calculated indexes 12 can be displayed with a reference value 13.

The user interface allows dragging and dropping employee actual competence profiles to move within the company structure, which automatically recalculates all indicators, so that the positive benefits of restructuring will be displayed immediately.

Whenever a change of the applicant data is performed:
change in turnover
change the rankings within a profile
adding skills
deleting skills
changing a group composition
changing a team composition
Etc.
   finds recalculation of the indexes on the separate server, that is possibly anonymous before sending the data and personalization to receive the calculated indexes for further internal processing.

Furthermore, the system allows the creation of new company units, for example, in the form of team building. After setting the target competence profile for the entity as such, or even for each of the new staff positions, the system calculates the optimum team composition by employee actual competence profiles of the selected indexes and suggests possible, optimal combinations. Furthermore, the system allows for the manual setting of an employee actual competence profile on one of the staff positions and the system under the new preset automatically optimizes the occupation of the remaining staff positions.

Furthermore, the system alerts the user when, an employee actual competence profile and/or index has a higher than a threshold deviation from the employee target competence profile and/or the target value of the index. This deviation may be due both to overworking as well as in a underworking of the employee.

Furthermore, the system alerts the user if a narrow passage occurs in the competence quality, where the competence quality results from the ratio of human potential from all different employee actual competence profiles of a company unit (superposition) and the sum of human potential values of all employees divided by the number of employees (representation). Conversely, the system also alerts the user when an increased knowledge redundancy is located in company units. The redundancy factor is calculated from the number of employees divided by the competence quality.

If the user data was collected during at least two time periods, indexes such as the effectiveness and stability of the economic temperature and the human potential can be calculated. Here, the stability results from the quotient of the human potential of the next period divided by temperature of the previous period, with the effectiveness being determined by the economic temperature of the subsequent period divided by the human potential in the previous period,

Further, it is possible to use the system for controlling the process of an operational structure. In addition to the previous indexes regarding the hard and the soft employee skills, workplace specific influencing factors may be liked to a staff position, for example information input/output, number of incoming/outgoing emails/letters/calls etc, climate, software, overtime, etc. The system allows a representation of the economic temperature depending on these factors, so that it becomes possible for a user, either by manually modifying individual targets to analyze the above-mentioned values to influence the economic temperature or by the system specifying certain free parameter ranges, to allow identification of those values that give the optimum economic temperature.

Within a specified operational structure a workplace defines which information are needed to perform duties on the job such as:

Type of information

Document

E-mail

A phone

Information content

Detailed description of the contents

Word document with precise content

Examples as Annex

Excel spreadsheet with accurate content

Examples as Annex

Other documents (invoices, etc.)

Examples as Annex

Identification of the sender

Identification of the operational structure

Specified Dates of Information input

Priority award

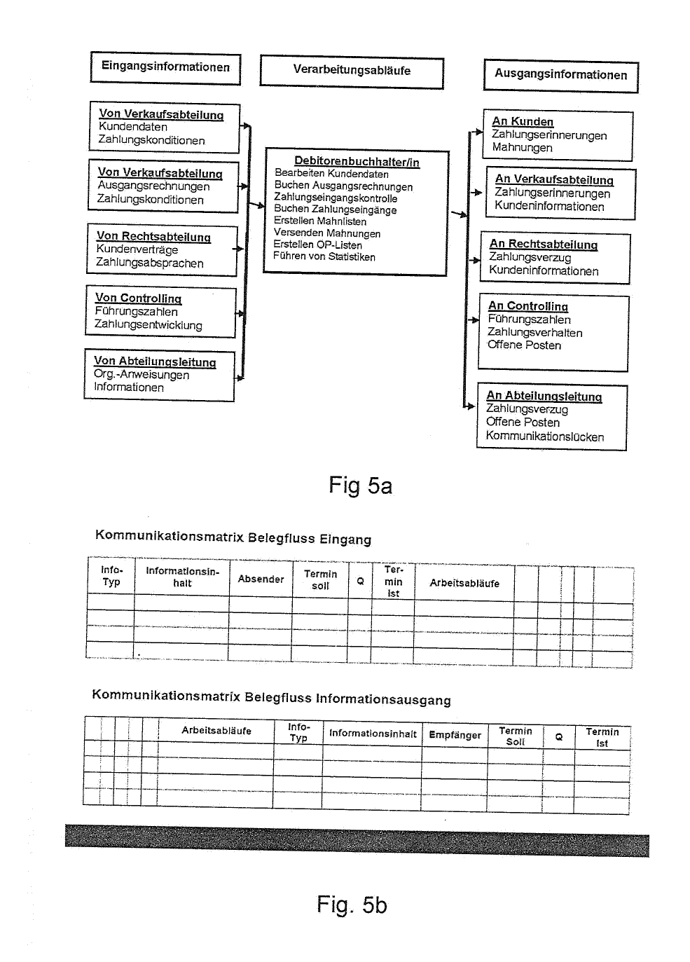

For each workflow, and for each workplace executing workflows the required information is defined, where the required input information depends on the processing operations, and where the required output information to the downstream processing operations as shown schematically in FIG. 5a. Thus in the case of an input document, e.g. an invoice, by reading and analysis of the document based on the defined operational structure, automatically a communication matrix is created in all the required inputs as output information is recorded as terminated as shown schematically in FIG. 5b.

The electronic readout of incoming and outgoing work documents may be preceded by documents in the paper form especially the scanned documents. If the documents are sent from the sender to the receiver through an electronic mail (EDI—Electronic Data Interchange), then electronic documents can be read and evaluated without this step to capture the information flows.
Thus, the communication matrix created for both the incoming as well as outgoing documents and information is constantly monitored and deviations are reported to the job owner. On initiative, the sender will automatically be prompted to provide the documents. Deviations are recorded in a log file. Every outgoing and incoming document is automatically (text recognition) checked in terms of completeness on the documents matrix. The document is automatically sent back to the sender with endorsements, Deviations are recorded in a log file.
As part of the assignment of an employee to a staff position, the communication matrix of a staff position is automatically sent to the associated employee target profile. Thus the employee receives specific instructions on what tasks and when he has to do, what information and when does the employee receive from the outside and from the inside, what information the employee does prepare and when it has to be sent outside and inside. So it can be automatically checked for each employee, whether the information has been provided by the correct date, and whether the information is provided in the right quality.
If a deadline is not met, the dispatcher will automatically receive a notice that certain information is missing. If the required quality or the required content is not delivered, the erroneous content is available automatically and the sender automatically received an indication that content is missing or incorrect.
Missing input information automatically affects the workflow and the work quality of the staff. The temperature rises automatically (triggered by the employee).
Errors in the organization process affect automatically the economic temperature at all levels. The temperature at all levels rises and appears in the organigramm. Graphic patterns show rashes that have to be analyzed. From a frequency of errors in the operational structure, to be determined by the user, hints are given e.g. by a color marking or by icon appearance, to the receiving and selling departments. This is only early detection of a narrow passage and the possibility to be able to intervene at an early stage.

1. A system for visualizing and simulating personal knowledge structures in a company that has one or more company units, comprising: a first server for storing a first set of data, describing a model of the company structure, wherein for each staff position in the company an employee target profile is defined, which includes an employee competence target profile; and for storing a second data set, which indicates the revenue generated for each individual company unit; and for storing a third set of data, which comprises captured an employee actual competence profile; a second server having a program that calculates, in particular, a human potential and/or the economic temperature from a plurality of indexes, based on the data of the first data set, second data set, and third data set; a graphical user interface which displays the calculated indexes for each employee actual competence profile and/or any company unit at a corresponding location in the above given company structure.

2. The system according to claim 1, wherein the graphical user interface is designed to assign an individual employee actual competence profile within the represented company structure to another staff position in the company structure through a user input, wherein automatic recalculation of the indexes takes place.

3. The system according to claim 1, wherein the graphical user interface is designed to obtain, through the user input, an optimized index for a selectable company unit, and then automatically reassign the employee actual competence profile to the staff positions in the company unit, which is the result of a sum of the indexes of the employee actual competence profiles optimized for the selected unit.

4. The system according to claim 1, wherein the graphical user interface is designed to create a newly defined company unit with at least one staff position, wherein for each of at least one employee position in the new defined company unit a new target profile is defined, wherein each target profile is automatically linked to an employee actual competence profile so that a predetermined index for the newly defined company unit is optimized.

5. The system according to claim 1, wherein the system is configured to alert the user when an employee actual competence profile or an index is deviating from the target profile or a reference index exceeds a defined threshold.

6. The system according to claim 1, wherein the system exhibits means which allows a manual change in at least one of the employee actual competence profiles, wherein an automatic recalculation of the indexes for all concerned company units is performed.

7. The system according to claim 1, wherein the employee target profile, for ach staff position in the company according to operational structure, defines workplace target profile, which includes the provided incoming and outgoing information influx, and wherein the system comprises:
a unit for detecting an incoming and outgoing flow of information, especially by reading incoming and outgoing work documents for each employee position, for detecting the workplace actual profile for each staff position in the company,
and a unit for adjusting the workplace target and actual profile for each staff position with respect to the operational structure, wherein the unit is marked at exceeding of a predefined deviation between the workplace target and the actual profile concerning an employee actual profile, and identifying them via the graphical user interface.

8. The system according to claim 7, comprising a unit for automatically notifying an information transmitter, if the transmitted information regarding workplace target profile for the receiving employee position is incomplete or delayed.

9. A method for visualizing and simulating personal knowledge structures in a company that has one or more company business units, comprising:
inputting a first data, which reflects the company structure and define an employee target profile for each staff position within a company structure, wherein the employees target competence profile include:
inputting a second data, which reflect the company's revenues in the company structure;
inputting a third recorded data, that depicts employee actual profile,
calculating predefined indexes based on the first data, the second data and third data, in particular, the human potential and/or the economic temperature;
displaying the company structures with a graphical user interface, wherein for each employee position of each company unit within the company structure calculated indexes in accordance with the corresponding, employee actual profiles are being displayed.

10. The method of claim 9, further comprising
coordination of individual employee actual competence profile within the represented company structure through a user input device to another staff position in the company structure,
and recalculating and updating the display of the indexes for each employee position.

11. The method according to claim 9, further comprising
selecting an index to be optimized for a company unit through the user input device, and automatic reassignment of employee actual competence profile on the staff positions in the company unit, wherein the sum of the indexes of the employee actual profiles for the selected company unit is maximized.

12. The method according to claim 9, further comprising
creating a new company unit with at least one employee position, having a target profile for each of the at least one employee positions defined in the new company unit, and
automatic association of each employee target profile with an employee actual competence profile, so that a predetermined index for the newly defined company unit is optimized.

13. The method according to claim 9, wherein the employee target profile for each staff position in the company comprises a workspace target profile according to an operational structure, which includes the provided incoming and outgoing information flow;
detecting an incoming and outgoing flow of information, especially by reading incoming and outgoing work documents for each employee position to capture the actual workplace profile for each staff position in the company,
balancing the target workplace and actual profile for each staff position with respect to the operational structure, wherein the exceeded predefined deviation between target employee workplace and an actual profile concerning employee actual profile is marked and displayed on the graphical user interface.

14. The method according to claim 13, comprising:
notifying automatically an information emitter, if the transmitted information
regarding workplace target profile for the receiving employee position is incomplete or delayed.
